(19) United States
(12) Patent Application Publication
(10) Pub. No.: US 2023/0222209 A1
(43) Pub. Date: Jul. 13, 2023

(54) DETECTION OF DUPLICATE INSTANCE ATTACK

(71) Applicant: R3 Ltd., London (GB)

(72) Inventor: Rui Almeida, London (GB)

(21) Appl. No.: 17/574,395

(22) Filed: Jan. 12, 2022

(51) Int. Cl. G06F 21/53; H04L 9/32

(52) U.S. Cl. CPC G06F 21/53; H04L 9/3236; G06F 2221/033

(57) ABSTRACT

A system is provided for detecting whether an application program executing in a secure enclave of a host computing system may be the target of a rewind attack. The system ensures that state information is consistent with messages that are received. The messages contain current ordering information, previous ordering information, and a related message identifier. When a message is received, the system determines whether the previous ordering information of the message and previous ordering information of the state information associated with the related message identifier are consistent. If not consistent, the system may indicate that a rewind attack is in progress because a malicious actor may have provided an out-of-date version of the state information. If consistent, the system updates previous ordering information of the state information that is associated with the related message identifier based on the current ordering information.

### BACKGROUND

Application programs store application information in storage that later needs to be retrieved. The application information that is stored represents the current version of the application information. When the application information is later retrieved by the application program, the application program can continue its execution with that application information. For example, an application program may receive messages from multiple client systems and store those messages in storage. The application program may need to perform computations based on those messages and store the results of the computations for later processing when a subsequent message is received. For example, companies that sell commodities may send pricing information to an organization that publishes commodity indices. When a message with pricing information for a commodity is received by the organization, the organization stores the pricing information and eventually calculates an index for the commodity from that pricing information. The application program of the organization stores the pricing information in an encrypted form and persistently in storage. To calculate the index, the application program retrieves the pricing information from storage, decrypts the pricing information, and calculates the index.

If the application program needs to restart execution, it may lose its current state (e.g., memory is cleared). In such a case, the application program may need to rely on application information that has been stored persistently. After restart, the application program retrieves the application information and continues execution.

Unfortunately, a malicious actor may attempt to mount a “rewind” attack against the application program. A malicious actor (e.g., computer code) may intercept and store the application information each time it is updated by the application program. The malicious actor thus maintains multiple prior “snapshots” of the application information. When the application program restarts and retrieves its application information, the malicious actor may provide a snapshot of the application information that is not the most current. When the application program does not maintain state across restarts, the application program may not be able to detect that it has been provided application information that is not the most current, which can present problems. For example, an organization that publishes a commodity index may, after restart, receive some pricing information and then decide to calculate an index based on that new pricing information and the pricing information previously received. If the application program is provided a snapshot of the application information that is not the most current, the application program will calculate the index using some out-of-date information and publish an index that is not accurate. Such an attempt by a malicious actor to provide a snapshot that is not the most current is referred to as a “rewind” attack because the application information is effectively rewound to a prior time. Since the application information is stored in encrypted form, the malicious actor cannot alter the information but can nevertheless provide encrypted, out-of-date application information as a rewind attack. In addition, a malicious actor may also intercept messages sent to the application program and store them and resend them at a later time to effectively replay the messages. Such replaying may allow the malicious actor to determine the content of a message to which the malicious actor is not authorized to access.

Some computer architectures provide a Trusted Execution Environment (TEE) for execution of trusted code (an application program) in a tamper-proof environment. The trusted code is stored as an “enclave.” The trusted code and its initial data are stored in memory in encrypted form and decrypted only when retrieved and stored in protected memory (EPC) for execution or use. Untrusted code, which is a code other than the trusted code, cannot inspect or interfere with the execution of the trusted code (at least without the permission of the trusted code). The TEE thus protects data at rest (within the TEE), in motion (between the TEE and storage), and during computation (within the TEE). The term “application” refers to a program that may include trusted code and untrusted code. The term “client” refers to code that interacts with the trusted code. The Intel Software Guard Extensions (SGX) and the ARM TrustZone are examples of a TEE. In the following, a TEE is described primarily in the context of SGX.

An enclave includes a trusted code and its data and a certificate of the author of the enclave. The certificate is referred to as an Enclave Signature (SIGSTRUCT). The enclave signature includes an enclave measurement, the author's public key, a Security Version Number (ISVSVN) of the enclave, and a Product ID (ISVPRODID) of the enclave. The enclave signature is signed using the author's private key. The enclave measurement is a hash of the trusted code and its initial data. When the code is loaded into protected memory (EPC), the CPU calculates a measurement and stores it in an MRENCLAVE register. If the calculated measurement is not equal to the enclave measurement, the CPU will not allow the enclave to be initialized within the TEE. After the enclave is initialized, the CPU stores a hash of the author's public key in a MRSIGNER register as an identifier of the author. The ISVSVN specifies the security level of the enclave. The ISVPRODID identifies the product the enclave represents. The CPU records both the ISVSVN and ISVPRODID.

A client that is to interact with an enclave (that has been initialized) would typically require the TEE to “attest” to the trusted code and data of the enclave. To provide an attestation to a client that may be executing on a platform that is different from the platform of the CPU that is executing the enclave (referred to as “remote” attestation), the TEE generates a “report” that includes the measurement (MRENCLAVE), hash of the author's public key (MRSIGNER), attributes of the enclave, and user data of the enclave. The report is passed to a quoting enclave (QE) to verify and sign the report. When verified, the QE generates a “quote” the includes the report and a signature of the TEE. The quote is then sent to the client.

Upon receiving a quote, the client can verify the signature and if verified, ensure that the report represents the trusted code that the client expects. The signature may be based on an Enhanced Privacy ID (EPID) in which different TEE have different private keys, but signatures based on those private keys can be verified using the same public key. The client may invoke the services of an EPID verification service to verify a signature on a quote.

An enclave that is to interact with another enclave that is executing on the same platform may want the other enclave to attest to its trusted code and data. In such a case, a simplified version of attestation can be used (referred to as “local” attestation). To initiate an attestation, the requesting enclave send its MRENCLAVE measurement to an attesting enclave. The attesting enclave requests the CPU to generate a report destined to the requesting enclave identified by the MRENCLAVE measurement that it received and sends the report to the requesting enclave. The requesting enclave then asks the CPU to verify the report. The attesting enclave may request the requesting enclave to provide an attestation to affect a mutual attestation.

A TEE provides support for an enclave to encrypt data that is to be stored outside of the TEE and to decrypt the encrypted data when it is later retrieved into the TEE. This encrypting and decrypting is referred to as “sealing” and “unsealing.” The TEE generates an encryption key and a decryption key based on a “fused key” that is not known outside of the hardware. The fused key is fused into the CPU hardware during the manufacturing process of the CPU, is not known outside of the CPU not even by the manufacturer, is unique to the CPU, and cannot be accessed except by the hardware. Upon request, the CPU generates a sealing key and unsealing key (e.g., public/private keypair) that is based on the fused key and data associated with the requesting enclave. Thus, each sealing key and unsealing key is unique to the CPU because the fuse keys are unique.

The CPU can generate two types of keys based on the associated data of the enclave that is used when generating the keys. The associated data is the MRENCLAVE (referred to as “sealing to the enclave”) or the combination of the MRSIGNER, ISVSVN, and ISVPRODID (referred to as “sealing to the author”). Data that is sealed to the enclave can only be unsealed by an enclave with the same MRENCLAVE value that is executing on the same CPU (i.e., using the same fused key) that generated the sealing key. Data that is sealed to the author can be unsealed by any enclave (e.g., different trusted code) of the author that has the same ISVPRODID and the same or an earlier ISVSVN (specified in a request to seal or unseal) and that is executing on the same CPU (i.e., using the same fused key) that generated the sealing key. (Note: The CPU will not generate seal-to-the-author keys for an ISVSVN that is greater than the ISVSVN of the enclave, which allows for only backward compatibility of sealing.) The TEE provides a seal application programming interface (API) for sealing data and an unseal API for unsealing data.

### BRIEF DESCRIPTION OF THE DRAWINGS

FIG. 1 is a block diagram that illustrates an SERW environment.

FIG. 2 is a flow diagram that illustrates the processing of a verify message component of the SED system in some embodiments.

FIG. 3 is a flow diagram that illustrates the processing of a perform verification component of the SERW system in some embodiments.

FIG. 4 is a flow diagram that illustrates the processing of an update POI table component of the SERW system in some embodiments.

FIG. 5 is a flow diagram that illustrates the processing of an application in some embodiments.

FIG. 6 is a flow diagram that illustrates the processing of a restart component of the DIA system in some embodiments.

FIG. 7 is a flow diagram that illustrates the processing of a receive hash component of a client in some embodiments.

FIG. 8 is a flow diagram that illustrates the processing of a validate state component of the DIA system in some embodiments.

### DETAILED DESCRIPTION

A method and system are provided for verifying whether state information retrieved from storage is consistent with data that is received from clients (“client data”) and/or represents a version of the state information that is not current. In some embodiments, a secure enclave (“SE”) application of a secure enclave may employ a secure enclave rewind (“SERW”) system to help detect rewind attacks by a host computer system that hosts the secure enclave. The SERW system helps ensure that a rewind attack by a malicious actor of a host computing system can rewind only to state information that is consistent with replayed client data. The SERW system can also detect that the state information is possibly not current in some instances. As used herein, the term “application” refers to a computer program that may conventionally be referred to as either an application program or a system program.

Methods and systems are also provided for handing a duplicate instance attack (DIA). A DIA system mitigates the effects of a duplicate enclave attack. A DIA occurs when an instance of an enclave is restarted with state information of another instance, which could result in a privacy breach. A host may start execution of multiple instances of an SE application of a secure enclave and route messages of some clients to one instance and messages of other clients to another instance. Each client may have previously performed an audit of the code of the SE application to ensure that the SE application will have the expected behavior. For example, each client can ensure that the SE application will only process messages from other clients that are approved to send such messages. Moreover, the SE application may allow each client to check what other clients are sending messages to that instance. In addition, each instance can generate an instance-specific public/private keypair that is unique to that instance and provide the public key to its clients. The instance can include the hash of its public key in its attestation report. When a client wants to connect to the instance, the TEE provides that attestation report and the public key to the client. The client can employ a verification service to verify the attestation. If the attestation is verified, the client can generate a hash of the public key it received and compare it to the hash of the public key of the attestation report. If they match, the public key corresponds to the private key of the enclave. The instance can encrypt messages that it sends to its client using the private key, and the client can encrypt the messages that it sends to the instance using the public key. The encrypting using a session-specific keypair ensures that if a malicious host sends those messages to another instance, that other instance will not be able to decrypt and process the messages. Similarly, each client can use the public key to verify a message was generated by that instance and not the other instance.

To ensure continued operation after a restart (e.g., after a power failure or maintenance shut down), each instance saves its state information (e.g., periodically) so that when the instance is restarted, it can be provided the state information that it saved and can resume execution based on that state information. After restart, an instance generates a session-specific keypair and provides it to its clients so they can resume interacting with the instance as described above. Each restart is considered a new session of that instance.

A malicious host (or malfunctioning host) may restart a first instance having first clients, not with its previously stored first state information, but with second state information previously stored by a second instance having second clients who are different from the first clients. In such a case, the two instances would be executing based on the same second state information—effectively duplicate instances. Although a first client could again start interacting with the restarted first instance (e.g., the malicious host computing system sends messages of the first client to the duplicate of the second instance) and detect that the restarted first instance does not have the correct first state information, the mere act of interacting with such a restarted instance may allow a second client to impermissibly identify that the first client is interacting with an instance of the SE application which could be a privacy breach associated with such a DIA.

One possible way to detect such a DIA would be for an instance to assign a sequence number each time it stores state information and provide that sequence number to its clients. On restart, the instance can send the sequence number to a client so that the client can confirm that it matches the last sequence number the client received. Unfortunately, with a DIA, the first state information of a first instance and the second state information of a second instance may happen to have the same sequence number. In such a case, the first client would not be able to detect the duplicate instance attack. The malicious host computing system might even be able to keep track of the number of saves of the state information of an instance and restart that instance with state information of another instance with the same number of saves.

To help detect a DIA and minimize the chance of a privacy breach, the DIA system generates a current hash of the state information and requests the host to store an encrypted form the state information. The DIA system then sends that current hash to its clients (e.g., broadcasts to all computing systems on a network). On restart, the instance is provided state information and generates a restart hash of the state information or sets the restart hash to the current hash stored as part of the state information. The instance may then broadcast the restart hash to all potential clients. A prior client of the restarted instance can compare the restart hash to the last current hash it received. If they are the same, the client can resume interacting with the restarted instance because the client knows the instance restarted with the state information that the client expects. If not the same, the client can take appropriate countermeasures such as not communicating with the restarted instance and notifying an authority that a DIA is in progress.

In some embodiments, the DIA system may generate a separate hash for the state information based on the state information associated with that client. The DIA system sends to each client the hash that is based on the state information associated with that client. If the state information of each client is stored separately, a malicious host computing system may provide the instance with correct state information for some clients and incorrect state information for other clients. In such a case, the clients with correct state information can interact with the host knowing that the instance has the correct state information. The clients with the incorrect state information may also be able to interact with the instance but it will be at their peril.

In some embodiments, a client may maintain a history of the prior hashes of the state information that it receives. If rewind attack is attempted after a restart of an instance, the current hash that the instance sends may corresponds to a prior hash that the client received that is other than the last prior hash received. For example, if the client has received five prior hashes 1-5, the current hash may match prior hash 3. If the current hash matches a such a prior hash, the client may decide to interact with the instance and possibly resend messages that were previously sent since such a prior hash was received. Continuing with the example, the client may resend messages that were sent after prior hash 3 was received. Even if the current hash does match the last prior hash received, the client may resend messages that were sent after the last prior hash was received.

Some problems can arise based on the order in which the instance persists the state information and sends the hash to the clients. The instance could first persist the state information (sequence A) or could first send the hash to the clients (sequence B).

With sequence A, the instance persists the state information, but the hash might be not be sent to the clients because of a disruption. For example, a power failure may occur before the instance can send the hash, or a malicious host may not forward the message with the hash to the clients. When the instance restarts, the instance calculates a restart hash and sends it to the clients. The clients, however, will not recognize the restart hash because the hash was not sent to it as a result of the disruption. Thus, the client will be unable to trust the state information because it does not know whether the hash represents state information of the instance it was connected to (the hash can be trusted) or the hash represents state information of a DIA or of a rollback attack to state information for which the client no longer stores the hash (the hash cannot be trusted).

With sequence B, the instance sends a hash that is received by the clients, but the state information might not be stored because of a disruption. For example, a power failure may occur before the state information can be persisted, or a malicious host may refuse to store it. When the client receives the restart hash after the instance restarts, it can (as described above) compare it to prior hashes to see if the state information is effectively a rollback and if so, resend messages that were sent after that hash was originally received. A client, however, may not be able to store prior messages (e.g., limited storage) or the time needed to re-process each message is prohibitive. A solution to the problem of sequence B is to have the client store at least one message (or the number of messages sent until the next hash is received) and two hashes. One hash is the hash of the non-persisted state information, and the other hash is the hash of prior persisted state information. Also, with sequence B, if a confirmation is sent after the state information is stored, the client could avoid storing prior messages. But if a confirmation was needed, sequence A may be more desirable since the receiving of the hash is also confirmation that the state information was stored.

The DIA system may employ a “persisted signed hash” to address the problems of sequence A. When the instance is restarted (or started initially), the instance generates a new public/private keypair and, as part of the attestation process, provides the public key to the clients who store the public key. Each time an instance stores its state information, it also stores a persisted signed hash that is the hash of the state information signed with the private key of the instance. Upon restart of the instance, the instance retrieves the state information and the persisted signed hash (if any). The instance generates a restart hash of the retrieved state information. The instance broadcasts the restart hash and the persisted signed hash to its clients.

Upon receiving the restart hash and the persisted signed hash, the client determines whether the restart hash is a hash that it previously stored. If so, the client can resume interacting with the instance assuming the state information represented by that hash. If the restart hash matches the persisted signed hash and the signature of the persisted signed hash can be verified with a public key that the client stores (from a prior restart), then the client can assume that it did not receive that persisted signed hash during a prior restart and can continue processing assuming the state information represented by the restart hash.

To detect a rewind attack, the SERW system can verify whether client data and state information provided by the host computing system are consistent or inconsistent and/or whether state information is not current. If inconsistent or not current, then the SERW system notifies the SE application so that appropriate countermeasures can be taken. The inconsistency may be a result of, for example, a malicious actor (e.g., the host computing system or a client) (1) providing state information that is an out-of-date version of the state information (e.g., a rewind attack), (2) replaying client data that is already reflected in the state information (i.e., old client data), or (3) providing client data that indicates that not all prior client data is reflected in the state information, referred to as a “gap” in client data.

The state information may not be current when there is a gap in client data. A gap a occurs, for example, when a malicious actor provides current state information to the SE application but fails to provide client data received from a client between 1:00 am to 5:00 am and then provides client data received from that client after 5:00 am. The client data received after 5:00 am would indicate that not all client data has been provided, that is, there is a gap in the client data. As another example, a gap occurs when a malicious actor provides old state information that was current at 1:00 am yesterday and replays the client data from 5:00 am yesterday without replaying the client data from 1:00 am to 5:00 am yesterday. As another example, a gap may occur even though the state information is current as a result of a malicious client sending client data that indicates some prior client data was not sent or a result of technical problems (e.g., non-delivery of client data, a bug in a client application).

When a gap occurs, the SERW system cannot definitively determine whether the state information provided by the host computing system was current or not current. The SERW system can, however, apply heuristics to effectively make an educated guess as to whether the state information is possibly current or possibly not current. For example, the heuristic may be based on whether the host computing system or clients appears to be malicious. If gaps occur in the client data of only a small percent of clients, then those clients may be malicious, and the state information is possibly current. If, however, gaps occur in the client data of a large percent of clients, then since it is unlikely that so many clients are malicious, the state information is possibly not current. The SERW system may employ a not current threshold to distinguish between the state information being possibly current or possibly not current. For example, the threshold may be based on the number or portion (e.g., >2%) of clients who sent gap client data or the amount of gap client data (e.g., received messages). When the not current threshold is satisfied, the state information may be characterized as possibly not current and may also have an associated confidence based on the amount of gap client data.

The SERW system can effectively “store” the state information by directing the host computing system to store an encrypted version of the state information or storing an encrypted version of the state information in a message that the SERW system sends to itself. The SERW system may periodically store current state information of the SE application to help ensure that the stored current state information represents current state information at a relatively recent time before execution of the SE application halts. After a restart, the host computing system provides an encrypted version of the state information that should be the current state information that was last stored by the SERW system. In addition, the host computing system provides client data that should be the client data received since the SE application halted execution. The SERW system decrypts the state information and provides the state information to the SE application. The SERW system then ensures that client data provided by host computing system and the state information are consistent. Thus, the SERW system defends against attacks perpetrated by a malicious actor such as replaying of client data, failing to provide client data (e.g., leaving gaps), rewinding of state information, and so on.

In some embodiments, the client data includes ordering information, and the state information includes previous ordering information for each client. The SERW system ensures that the previous ordering information of client data for a client and previous ordering information of the state information for that client are consistent. When they are consistent, the SE application can process the client data based on the state information. If they are not consistent, an attack may be being attempted and the SE application can take countermeasures, such as shutting down or sending a notification to a trusted authority.

In some embodiments, when the secure enclave is provided a current message (i.e., current client data) by the host computing system, the SERW system verifies that the current message and the state information of the SE application are consistent. The current message includes ordering information and a related message identifier. The messages provided secure enclave may be, for example, emails or posts. The related message identifiers may be, for example, the sender of a message or topic of the message. The ordering information may be unique message identifiers (e.g., time of previous email, sequence number, or hash of an email) that uniquely identify each message associated with a related message identifier. The SERW system stores the messages in storage controlled by the host and may maintain a previous ordering information (“POI”) data structure (as part of the state information) that maps related message identifiers to previous ordering information associated with the related message identifiers. For example, the POI data structure may be a table that maps sender identifiers to the time of the last email (e.g., sent time that is included in the email) received from the identified sender.

In some embodiments, the SERW system may employ implicit or explicit ordering information. Ordering information is implicit when ordering information of a previous message can be determined from ordering information of a current message. For example, if the messages are numbered sequentially by the sender, then the message number of the previous message (i.e., previous ordering information) can be determined from the message number of the current message. Ordering information is explicit when the current message contains both the current ordering information of the current message and the current ordering information of the previous message (i.e., previous ordering information). For example, if the messages are time-stamped, then the current message may contain the time of the current message and the time of the previous message.

Upon receiving a message, the SERW system may decrypt the message and extract the related message identifier and the ordering information, which may include current ordering information and previous ordering information. The SERW system retrieves from a POI table the previous ordering information that is associated with the related message identifier. The SERW system then decrypts the previous ordering information and determines whether the previous ordering information from the POI table is consistent with the ordering information of the message. If they are not consistent, then the host computing system may be malicious by rewinding state information, replaying messages, and so on. If they are consistent, the SERW system may re-encrypt the message and store the re-encrypted message in SE storage and update the POI table so that the current ordering information stored as the now-previous ordering information associated with the related message identifier. The SERW system may decrypt messages using a private key (e.g., of the secure enclave or the SERW system) and encrypt and decrypt data stored in SE storage using public/private key pairs or symmetric keys. The SERW system may use the public key associated with a sender of a message (or message identifier) to ensure that the message was signed by the sender. Alternatively, the SE application may be responsible for the encryption and decryption. Some secure enclaves may automatically encrypt and decrypt data sent to and received from SE storage.

In some embodiments, the SERW system effectively stores state information (e.g., the POI table) persistently for the SE application. When the SE application wants to maintain state information persistently (e.g., across restarts), the SERW system encrypts a state message that includes the state information and sends the state message to itself. For example, the SERW system may send the state message to a third party (e.g., a client) who later sends the state message for delivery to the SERW system or sends the state message directly to itself. The SERW system may send a state message with state information that is specific to a client to the client. The client can then send the state information to the SERW system along with a client message. When the state message is received (e.g., after restart), the SERW system decrypts the state message to retrieve the state information. The SE application may employ the SERW system as a checkpointing service. To create a checkpoint, the SERW system sends a state message. When state messages are delivered (e.g., after a restart), the SERW system may process the state messages until one is processed with previous ordering information that is consistent with the previous ordering information of the POI table. The SERW system may send a state message with state information that is specific to a client to that client so that the client can then send the state information to the SERW system. Upon receiving state information from a client, the SERW system will know that the state information is for the sending client. The SERW may also include a hash of the messages stored in the SE storage in the state messages to confirm that the state information is consistent with those messages—those messages may be subject to a rewind attack by the host computing system.

In some embodiments, the SERW system may encrypt and store state information in SE storage rather than include the state information in a state message. When the SERW application stores the state information, the SERW system may store previous ordering information in the POI table and send a state message with the previous ordering information. When the SE application receives a state message, the SERW system ensures that the previous ordering information of the state message is consistent with the previous ordering information of the POI table. If they are consistent, the SE application may assume that state information of the SE storage is valid state information—albeit possibly not the most current state information stored by the SE application because of an attempted rewind attack.

In some embodiments, an SE application may handle messages associated with millions of different message identifiers (e.g., cell phone numbers). The overhead in maintaining a POI table with millions of records may be prohibitive. To help lessen the overhead, the SERW system may store previous ordering information for only a subset (e.g., 10%) of the related message identifiers. When only a subset is stored, the detection of an attempted rewind attack may be delayed until a message associated with a message identifier in the subset is received. But, depending on the type of data processed by the SE application, the delayed detection may be acceptable.

In some embodiments, an SE application may assume that clients that send messages are trusted in the sense that they will correctly identify the previous ordering information. However, if a client is malicious and sends incorrect ordering information in a message, the SERW system may incorrectly assume that the host computing system is malicious. The SE application may implement a malicious host criterion to determine whether the host computing system or a client is malicious. For example, the malicious host criterion may be satisfied when inconsistent ordering information has been received from a certain percentage (e.g., 2.0%) of the clients. If the malicious host criterion is satisfied, the SE application may assume that the host computing system is malicious by providing rewound state information or replaying messages. If the criterion is not satisfied, the SE application may assume that any inconsistent ordering information is caused by a malicious client. The malicious host criterion may be based on a rolling time window so that infrequent instances of inconsistent ordering information resulting from malicious or malfunctioning client systems do not accumulate over time to satisfy the malicious host criterion.

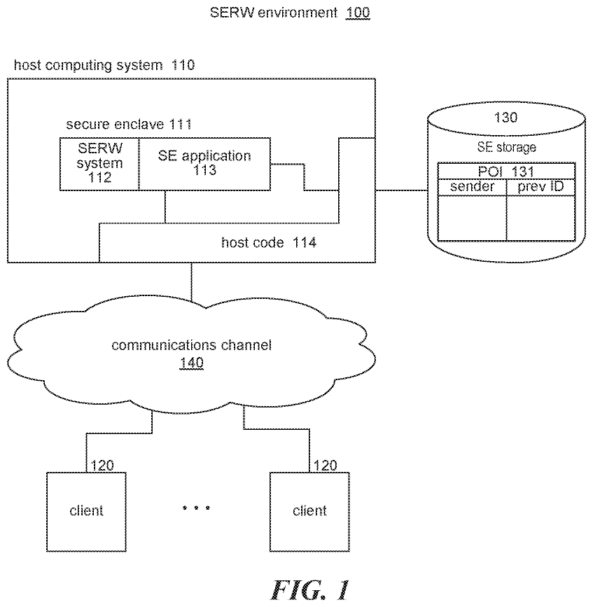

FIG. 1 is a diagram that illustrates an SERW environment. In some embodiments, an SERW environment 100 includes a host computing system 110, client systems 120, SE storage 130, and a communications channel 140. The host computing system includes a secure enclave 111 and host code 114 that may be malicious. An SERW system 112 and an SE application 113 execute within the secure enclave environment. The client systems communicate with the host computing system via the communications channel. The host code receives encrypted client data from the client systems and encrypted application data (e.g., emails) from the SE storage and provides the encrypted data to the SE application, and it receives encrypted application data from the SE application and stores the encrypted application data to the SE storage. The SE storage stores SE application data and state information that includes the POI table 131, which contains a record for each sender and the previous ordering information of the sender. The SE storage may be any type of persistent storage. Rather than being stored in SE storage, the state information may alternatively be stored in a state message that the SE application sends to itself.

In some embodiments, the code of the SERW system may be part of the SE application (e.g., within executable code of the SE application) or a separate service provided to the application. In addition, some of the functions of the SERW system may be implemented as part of the application and other functions may be provided by the separate service. For example, the host computing system may provide messages directly to the SE application, and the SE application may invoke components of the separate service to verify that the messages and state information are consistent. Alternatively, the host computing may provide messages directly to the SERW system as a separate service which verifies the messages and provides them to the SE application.

The term “secure enclave” refers to a feature of a central processing unit (“CPU”) in which code and data of code (i.e., trusted code) are stored in external memory or persistent storage) in encrypted form and decrypted only when retrieved for use by the CPU. Such code is said to execute in the secure enclave. A secure enclave has internal memory that is used by code executing within the secure enclave to store its data that includes its state. The internal memory is, however, not persistent. So, when the secure enclave halts execution (e.g., host computing system is rebooted), the state stored in the internal memory is lost. So, when the secure enclave restarts execution, the internal memory no longer stores the state. Thus, the code needs to retrieve its state from an external source to resume execution based on the state of the code when execution of the secure enclave halted.

To ensure that the code executing in a secure enclave is trusted code (e.g., the code that is expected), the CPU supports generating an attestation of the trusted code (e.g., the SE application and the SERW system) that executes in the secure enclave. The attestation includes a hash of the trusted code, an identifier of the CPU, and application data. The attestation is encrypted or signed by a CPU private key of a CPU public/private key pair that is stored in the CPU during manufacture of the CPU. The trusted code requests the CPU to provide the attestation and then provides the attestation to client code as evidence of the trusted code that executes in the secure enclave. The client code can request a service (of the manufacturer of the CPU) to provide the CPU public key of the CPU public/private key pair to decrypt or verify the signature. The client code can extract the hash to verify that the trusted code is the expected code and extract the application data. Such a secure enclave is provided by the Software Guard Extensions (“SGX”) feature provided by Intel Corporation.

Application data of an application that is executing within a secure enclave is encrypted before being stored in storage and decrypted when retrieved from storage. In addition, client data (e.g., messages) received from client systems is encrypted and decrypted after being received. Similarly, data sent to client systems is encrypted and then decrypted by the client system. The data is considered to be stored in an encrypted form. The data can be encrypted and decrypted either by the application or the secure enclave environment provided by the hot computing system. When data is described without the adjective “decrypted” or “encrypted,” it is considered to be in an unencrypted form whether decrypted from encrypted data or created in an unencrypted form.

The computing systems (e.g., nodes) on which the SERW system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the SERW system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SERW system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the SERW system may be implemented in hardware using, for example, an application-specific integrated circuit (ASIC) or field programmable gate array (“FPGA”).

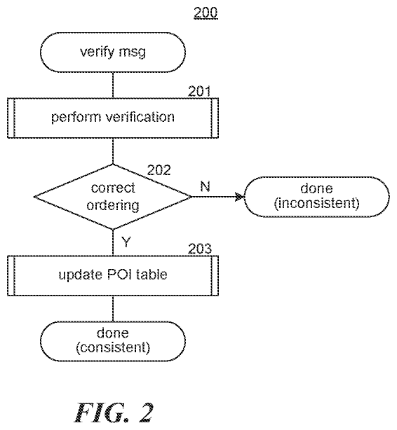

FIG. 2 is a flow diagram that illustrates the processing of a check consistency component of the SERW system in some embodiments. The check consistency component 200 is invoked by the SE application to verify whether state information and a current message are consistent by checking whether the current message is the correct next message. In block 201, the component invokes a perform verification component to verify that the previous ordering information of the current message and the previous ordering information of the POI table indicate a correct ordering. In decision block 202, if the ordering has been verified as correct, then the component continues at block 203, else the component completes indicating that the state information and the current message are inconsistent. In block 203, the component invokes an update POI table component to update the POI table with the previous ordering information based on current message. The component then completes indicating that the state information and the current message are consistent.

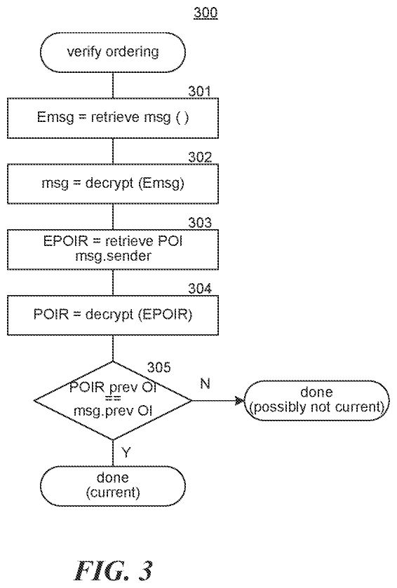

FIG. 3 is a flow diagram that illustrates the processing of a verify ordering component of the SERW system in some embodiments. The verify ordering component 300 is invoked to verify that the ordering of current message and the previous message based on the ordering information of the current message and previous ordering information of the POI table. In block 301, the component retrieves the encrypted current message. In block 302, the component decrypts the encrypted current message. In block 303, the component retrieves from the POI table the record (“POIR”) for the sender of the current message. In block 304, the component decrypts the encrypted record. In decision block 305, if the previous ordering information of the record and the ordering information of the current message indicates a correct ordering, then the component completes indicating that the ordering is correct, else the component completes indicating that the ordering is not correct.

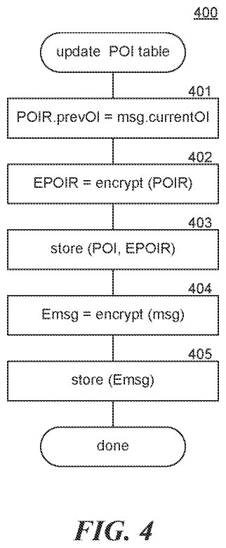

FIG. 4 is a flow diagram that illustrates the processing of an update POI table component of the SERW system in some embodiments. The update POI table component 400 is invoked to update a record in the POI table for a sender (i.e., client) with new previous ordering information. In block 401, the component sets the previous ordering information of the record based on ordering information of the current message. In block 402, the component encrypts the record. In block 403, the component stores in the POI table the encrypted record. In block 404, the component encrypts the current message. In block 405, the component stores the encrypted current message in the secure enclave storage or internal memory to be part of a state message and then completes.

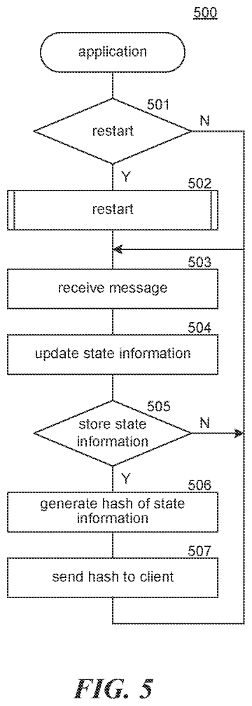

FIG. 5 is a flow diagram that illustrates the processing of an application in some embodiments. The application 501 when processing messages for a client employs the DIA system to send hashes of state information to the client. In decision block 501, if the application is executing in a restarted instance, then the application continues at block 502, else the application continues at block 503. In block 502, the application invokes a restart component. In block 503, the application receives a message from the client. In block 504, the application updates the state information based on the message. In decision block 505, if the state information is to be stored persistently (e.g., hard drive), then the application continues at block 506, else the application loops to block 503 to process the next message. In block 506, the application generates a hash of the state information and directs the storing of the state information. In block 507, the application sends the hash to the client and loops to block 503 to process the next message.

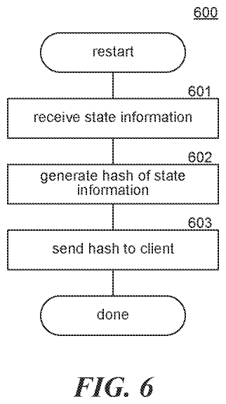

FIG. 6 is a flow diagram that illustrates the processing of a restart component of the DIA system in some embodiments. The restart component 600 is invoked on restart of an instance of an application. In block 601, the component receives state information (e.g., stored by the host). In block 602, the component generates a hash of the state information. In block 603, the component sends the hash to the client.

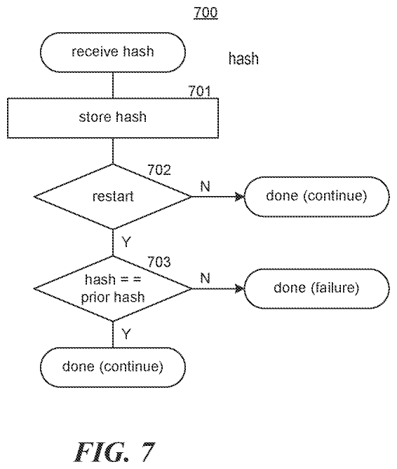

FIG. 7 is a flow diagram that illustrates the processing of a receive hash component of a client in some embodiments. The receive hash component 700 is invoked when the client receives a hash from an instance of an application. In block 701, the component stores the hash. In decision block 702, if the instance has restarted, then the component continues at block 703, else the component completes. In decision block 703, if the hash equals a prior hash received from the instance, then the component completes so that processing can continue assuming state information associated with that prior hash, else the component completes indicated a failure of state.

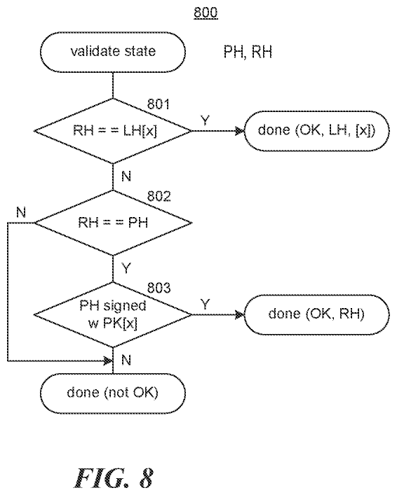

FIG. 8 is a flow diagram that illustrates the processing of a validate state component of the DIA system in some embodiments. PH represents a persisted signed hash, RH represents a restart hash, and LH[−n . . . −1] represents the last n hashes received with LH[−1] representing the last hash received before this restart. The validate state component 800 is invoked to validate the current state information of an instance after a restart. If validated, the component indicates what should be considered the most recently received last hash. In decision block 801, if the restart hash matches a last hash[x], then the component completes indicating that the restart is valid with state information consistent with that last hash, else the component continues at block 802. If there is a match, then the DIA system knows that it can continue assuming the state information at the time of the matching last hash. If x is not −1 (i.e., index of the last hash received before this restart), there may have been a rollback attack and the DIA system can then decide how to handle this situation. The DIA system could resend messages sent after that last hash was received, notify an authority of the situation, and so on. In decision block 802, if the restart hash matches the persisted signed hash, then the component continues at block 803, else the component completes indicating that the restart is not valid. If the restart hash matches the persisted signed hash (but not any last hash), the persisted signed hash was not received by the DIA system during the prior restart (or initial start). In such a case, the DIA system can assume that the restart hash is the hash it would have received during the last restart but for the disruption if the signature of the persisted signed hash can be verified with the public key of the last restart. In decision block 803, if the persisted signed hash is verified with the public key of the last restart, then the component completes indicating that the restart is valid and the last hash received is now the restart hash, else the component completes indicating the restart is not valid.

The computing systems (e.g., nodes) on which the SERW system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the SERW system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SERW system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the SERW system may be implemented in hardware using, for example, an application-specific integrated circuit (ASIC) or field programmable gate array (“FPGA”).

The following paragraphs describe various embodiments of aspects of the SERW system. An implementation of the SERW system may employ any combination of the embodiments. The processing described below may be performed by a computing device with a processor that executes computer-executable instructions stored on a computer-readable storage medium that implements the SERW system.

A method performed within a secure enclave of a host computing system that is executing an application is provided to determine whether application information of the application and client data provided to the secure enclave by the host computing system are consistent. The method accesses encrypted client data provided by the host computing system. The encrypted client data includes ordering information and a related data identifier. The method decrypts the encrypted client data. The method accesses encrypted application information provided by the host computing system. The encrypted application information includes previous ordering information that is associated with the related data identifier. The method decrypts the encrypted application information. The method determines whether the ordering information and the previous ordering information indicates an ordering that is correct. The method indicates that the application information and the client data are not consistent based on the determination. In some embodiments, when the ordering information and the previous ordering information or determined to be correct, the method updates the application information to have new previous ordering information associated with the related data identifier. The new previous ordering information is based on the ordering information. In some embodiments, the new previous ordering information is stored in a previous ordering information data structure that includes previous ordering information for each of multiple related data identifiers. In some embodiments, the method further stores of the client data in encrypted form in persistent storage. In some embodiments, when the ordering information and the previous ordering information are determined to be not correct, the method indicates that the client data and the application information are inconsistent. In some embodiments, the client data is a message and the related data identifier is based on a sender of the message. In some embodiments, the related data identifier is based on a topic associated with the client data. In some embodiments, the client data includes current ordering information and previous ordering information and the determining is based on the current ordering information of the client data and the previous ordering information of the application information. In some embodiments, the client data includes current ordering information and the determining is based on the current ordering information and the previous ordering information.

In some embodiments, a method performed within a secure enclave of a computing system is provided for detecting whether stored information stored in storage is inconsistent with a message. The method accesses a message that is received by the secure enclave. The message includes current ordering information, previous ordering information, and a related message identifier. The message is received in an encrypted form and decrypted. The method accesses a previous ordering information data structure that includes, for each of multiple related message identifiers, previous ordering information associated with that related message identifier. The previous ordering information is stored in an encrypted form. The method indicates whether the accessed previous ordering information and the stored information are consistent with the stored information based on the previous ordering information of the message and the previous ordering information data structure. In some embodiments, when the previous ordering information and the stored information are consistent, the method stores new previous ordering information in association with the related message identifier of the message. In some embodiments, the new previous ordering information is stored in a previous ordering information data structure that includes previous ordering information for each of multiple related message identifiers. In some embodiments, the related message identifier is unique to a sender of the message. In some embodiments, the related message identifier is based on a topic associated with the message.

In some embodiments, a method performed in a secure enclave environment of a host computing system is provided for persisting state information of an application. The method encrypts a state message that includes the state information. The method directs the host computing system to send the encrypted state message to the application. The method, after execution of the application halts and is restarted, receives from the host computing system the encrypted state message. The method decrypts the encrypted state message. The method initializes state information of the executing application to the state information of the decrypted state information. In some embodiments, the state message includes an application identifier that identifies the application. In some embodiments, the state message is sent to a client system and the client system then sends a message with the state information to the application. In some embodiments, the method, after a client message is received from a client, determines whether the state information and the client message are consistent based on ordering information of the client message and previous ordering information of the state information. In some embodiments, the state message is sent to create a checkpoint for the application.

In some embodiments, a method performed by a secure enclave of a host computing system is provided for determining with state information is current. The method receives from a plurality of client messages, each client message including ordering information. For each client message, the method determines whether the ordering information of that client message is consistent with previous ordering information of the state information. The method indicates that the state information is possibly not current when client messages that are determined to be inconsistent satisfy a not current threshold. The method indicates a confidence level associated with the indication. In some embodiments, the not current threshold is based on clients that sent gap client data. In some embodiments, the not current threshold is based on gap client data and not clients that sent gap client data. In some embodiments, the not current threshold is based on a number of clients that sent gap client data and an amount of gap client data.

In some embodiments, a host computing system that provides a secure enclave for execution of an application and for verifying whether application information of the application that is provided to the secure enclave by the host computing system is consistent with received data. The host computing system comprises one or more computer-readable storage mediums for storing computer-executable instructions and one or more processors for executing the computer-executable instructions stored in the one or more computer-readable storage mediums. The instructions control the secure enclave to receive from the host computing system encrypted data that includes ordering information and a related data identifier. The instructions control the secure enclave to decrypt the encrypted data. The instructions control the secure enclave to receive from the host computing system encrypted application information that was previously provided by the secure enclave to the host computing system. The encrypted application information includes previous ordering information that is associated with the related data identifier. The instructions control the secure enclave to decrypt the encrypted application information. The instructions control the secure enclave to determine whether the decrypted application information and the decrypted data are consistent based on the ordering information and the previous ordering information being consistent. In some embodiments, the instructions further for controlling the secure enclave to, when the ordering information and the previous ordering information are consistent, update the decrypted application information with new previous ordering information that is associated with the related data identifier. In some embodiments, the application information includes previous ordering information for each of multiple related data identifiers. In some embodiments, wherein the data is a message and the related data identifier is based on a sender of the message. In some embodiments, the related data identifier is based on a topic associated with the data. In some embodiments, the instructions further for controlling the secure enclave to generate re-encrypted application information by encrypted the decrypted application information and providing the re-encrypted application information to the host computing system so that the host computing system can provide the re-encrypted application information to the secure enclave after a restart of the secure enclave.

In some embodiments, a method performed by an application of a secure enclave executing on a host computing system is provided to support a client determining whether current application state of an instance of the application is consistent with prior application state of the instance. The processes client data received from clients to generate prior application state. The method generates a prior hash of the prior application state. The method sends the prior hash to a client. The method requests the host computing system to store the current application state. The method, upon restart of execution of the instance of the application of the secure enclave, receives current application state from the host computing system and sends a current hash of the current application state to the client so that the client can compare the current hash and the prior hash to determine whether the current application state is the same as the prior application state. In some embodiments, the method receives a message from the client that includes a hash of application state and determines whether received hash is the same as the current hash to ensure that the message is consistent with the current application state. In some embodiments, the application maintains client-specific application state for each of plurality of clients and wherein the prior hash sent to the client is a hash of the client-specific application state for that client. In some embodiments, the method during the restarted execution of the instance the application, generates a new current hash of new current application state that is different from the current application state and sends the new current hash to the client. In some embodiments, the new current hash is sent to the client via a reply message to a message received from the client. In some embodiments a new current hash is periodically calculated and sent to the client. In some embodiments, the method further upon restarting execution of the instance of the application, generates the current hash of the current application state. In some embodiments, the method upon restart of execution of the instance of the application, receives from the host computing system the current hash.

In some embodiments, a method performed one or more computing systems is provided for determining whether current application state of an instance of an application of a secure enclave executing on a host computing system is consistent with prior application state. The method receives a prior hash of prior application state of the instance of the application. After execution of the instance of the application is restarted, the method receives an attestation of the secure enclave and a public key of the application. The attestation includes a hash of code of the application and a hash of the public key of the application. The method verifies the attestation and verifies that a hash of the received public key matches the hash of the attestation. The method receives from the instance of the application a current hash of current application state of the instance. The method determines whether the prior hash matches the current hash. In some embodiments, the received current hash is encrypted with a private key corresponding to the public key and the method further decrypts the received current hash using the public key. In some embodiments, the method upon determining that the prior hash does not match the current hash, suppresses communications with the instance. In some embodiments, the method determines whether the current hash matches a prior hash other than the last prior hash that was received. In some embodiments, the method resends messages sent to the instance after the prior hash was received.

In some embodiments, one or more computing systems with a trusted execution environment (TEE) are provided for providing to a client of an instance of an application of a secure enclave executing within a TEE evidence of current application state of that instance. The one or more computing systems include one or more computer-readable storage mediums storing computer-executable instructions for controlling the one or more computing systems during execution of the instance and one or more processors for executing the computer-executable instructions stored in the one or more computer-readable storage mediums. The instructions control the one or more computing systems generate a first hash of first application state of the instance, send the first hash to the client, and direct a computing system to store the first application state persistently. Upon restart of execution of the instance, the instructions control the one or more computing systems to receive second application state from a computing system and send a second hash of the second application state to the client so that the client can compare the first hash and the second hash to determine whether second application state is the same as the first application state. In some embodiments, the instructions include instructions to receive a message from the client that includes a hash of application state and determine whether received hash is the same as the second hash to ensure that the message is consistent with the second application state. In some embodiments, the application maintains client-specific application state for each of plurality of clients and wherein the first hash sent to the client is a hash of the client-specific application state for that client. In some embodiments, the instructions include instructions to, during the restarted execution of the instance of the application, generate a third hash of third application state that is different from the second application state and send the third hash to the client. In some embodiments, the third hash is sent to the client via a reply message to a message received from the client. In some embodiments, a new current hash is periodically generated based on the then-current application state and sent to the client. In some embodiments, the instructions include instructions to, upon restarting execution of the instance of the application, generate the second hash of the second application state. In some embodiments, the instructions include instructions to, upon restarting execution of the instance of the application, receive from one of the computing systems the second hash.

In some embodiments, a method performed by an application of a secure enclave executing on a host computing system is provided to support a client determining whether current application state of an instance of the application is consistent with prior application state of the instance. The method processes client data received from clients to generate prior application state. The method generates a prior hash of the prior application state. The method sends prior hash to a client. Upon restart of execution of the instance of the application of the secure enclave, the method receives current application state from the host computing system and sends a current hash of the current application state to the client so that the client can compare the current hash and the prior hash to determine whether the current application state is the same as the prior application state. In some embodiments, the method receives a message from the client that includes a hash of application state and determines whether the received hash is the same as the current hash to ensure that the message is consistent with the current application state. In some embodiments, the application maintains client-specific application state for each of plurality of clients and wherein the prior hash sent to the client is a hash of the client-specific application state for that client. In some embodiments, the method during the restarted execution of the instance of the application generates a new current hash of new current application state that is different from the current application state and sending the new current hash to the client. In some embodiments, the new current hash is sent to the client via a reply message to a message received from the client. In some embodiments, a new current hash is periodically calculated and sent to the client. In some embodiments, the method, upon restarting execution of the instance of the application, generates the current hash of the current application state. In some embodiments, the method, upon restarting execution of the instance of the application, receives from the host computing system the current hash.

In some embodiments, a method performed one or more computing systems is provided for determining whether current application state of an instance of an application of a secure enclave executing on a host computing system is consistent with prior application state. The method receives a prior hash of prior application state of the instance of the application. A execution of the instance of the application is restarted, the method receives an attestation of the secure enclave and a public key of the application, the attestation including a hash of code of the application and a hash of the public key of the application. The method verifies the attestation and that a hash of the received public key matches the hash of the attestation. The method receives from the instance of the application a current hash of current application state of the instance. The method determines whether the prior hash matches the current hash. In some embodiments, the received current hash is encrypted with a private key corresponding to the public key and further comprising decrypting the received current hash using the public key. In some embodiments, the method further, upon determining that the prior hash does not match the current hash, suppresses communications with the instance. In some embodiments, the method further determines whether the current hash matches a prior hash other than the last prior hash that was received. In some embodiments, the method further resends messages sent to the instance after the prior hash was received.

In some embodiments, one or more computing systems with a trusted execution environment (TEE) are provide for providing to a client of an instance of an application of a secure enclave executing within a TEE evidence of current application state of that instance. The one or more computing systems including one or more computer-readable storage mediums storing computer-executable instructions for controlling the one or more computing systems and one or more processors for executing the computer-executable instructions stored in the one or more computer-readable storage mediums. The instructions including instructions to, during execution of the instance, generate a first hash of first application state of the instance, send the first hash to the client, and direct a computing system to store the first application state persistently. The instructions further include instructions to, upon restart of execution of the instance, receive second application state from a computing system and send a second hash of the second application state to the client so that the client can compare the first hash and the second hash to determine whether second application state is the same as the first application state. In some embodiments, the instructions further include instructions to receive a message from the client that includes a hash of application state and determine whether received hash is the same as the second hash to ensure that the message is consistent with the second application state. In some embodiments, the application maintains client-specific application state for each of plurality of clients and wherein the first hash sent to the client is a hash of the client-specific application state for that client. In some embodiments, the instructions further include instructions to, during the restarted execution of the instance of the application, generate a third hash of third application state that is different from the second application state and send the third hash to the client. In some embodiments, the third hash is sent to the client via a reply message to a message received from the client. In some embodiments, a new current hash is periodically generated based on the then-current application state and sent to the client. In some embodiments, the instructions further include instructions to, upon restarting execution of the instance of the application, generate the second hash of the second application state. In some embodiments, the computer-executable instructions further include instructions to, upon restarting execution of the instance of the application, receive from one of the computing systems the second hash.

In some embodiments, a method performed by one or more computing systems is provided for verifying state information of a secure enclave. Upon restart of an instance of the secure enclave, the method receives a restart hash of state information loaded by that restarted instance, receives a persisted signed hash loaded by that restarted instance, and validates the state information based on the restart hash matching a previous hash received from a prior start of that instance or based on the restart hash matching the persisted signed hash and verification that the persisted signed hash was signed using a private key corresponding a public key received from a prior restart of that instance. In some embodiments, a prior start is an initial start of the instance. In some embodiments, a prior start is a prior restart of the instance. In some embodiments, the method further receives and storing a public key of a public/private keypair of the restarted instance, the public key being unique to that restarted instance. In some embodiments, the method further receives a current hash of current state information of the instance and storing the current hash as a previous hash.

In some embodiments, one or more computing systems are provided for providing evidence of state information of an instance of an application of a secure enclave. The one or more computing systems including one or more computer-readable storage mediums storing computer-executable instructions for controlling the one or more computing systems and one or more processors for executing the computer-executable instructions stored in the one or more computer-readable storage mediums. The instructions include instructions to, upon a start of the instance of the application, send to a client a public key of the public/private keypair of the start of the instance, generate a hash of state information of the instance, sign the hash with the private key of the public/private keypair, and store the state information and the signed hash. The instructions further includes instructions to, upon restart of the instance of the application, receive current state information and the signed hash, generate a current hash of the current state information, and send to the client the current hash and the signed hash so that the client can verify that the current hash matches the signed hash and verify using the public key that the signed hash was signed using the private key. In some embodiments, the instructions further include instructions to generate a public/private keypair for the start of the instance. In some embodiments, the instructions that store request a host computing system to persistently store the state information and the signed hash. In some embodiments, the current state information is received from a host computing system.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by an application of a secure enclave executing on a host computing system to support a client determining whether current application state of an instance of the application is consistent with prior application state of the instance, the method comprising:
processing client data received from clients to generate prior application state;
generating a prior hash of the prior application state;
sending the prior hash to a client; and
upon restart of execution of the instance of the application of the secure enclave, receiving current application state from the host computing system; and
sending a current hash of the current application state to the client so that the client can compare the current hash and the prior hash to determine whether the current application state is the same as the prior application state.

2. The method of claim 1 further comprising:
receiving a message from the client that includes a hash of application state; and
determining whether the received hash is the same as the current hash to ensure that the message is consistent with the current application state.

3. The method of claim 1 wherein the application maintains client-specific application state for each of plurality of clients and wherein the prior hash sent to the client is a hash of the client-specific application state for that client.

4. The method of claim 1 further comprising during the restarted execution of the instance of the application, generating a new current hash of new current application state that is different from the current application state and sending the new current hash to the client.

5. The method of claim 4 wherein the new current hash is sent to the client via a reply message to a message received from the client.

6. The method of claim 4 wherein a new current hash is periodically calculated and sent to the client.

7. The method of claim 1 further comprising upon restarting execution of the instance of the application, generating the current hash of the current application state.

8. The method of claim 1 further comprising upon restarting execution of the instance of the application, receiving from the host computing system the current hash.

9. A method performed one or more computing systems for determining whether current application state of an instance of an application of a secure enclave executing on a host computing system is consistent with prior application state, the method comprising:
receiving a prior hash of prior application state of the instance of the application; and
after execution of the instance of the application is restarted,
receiving an attestation of the secure enclave and a public key of the application, the attestation including a hash of code of the application and a hash of the public key of the application;
verifying the attestation and that a hash of the received public key matches the hash of the attestation;
receiving from the instance of the application a current hash of current application state of the instance; and
determining whether the prior hash matches the current hash.

10. The method of claim 9 wherein the received current hash is encrypted with a private key corresponding to the public key and further comprising decrypting the received current hash using the public key.

11. The method of claim 9 further comprising upon determining that the prior hash does not match the current hash, suppressing communications with the instance.

12. The method of claim 9 further comprising determining whether the current hash matches a prior hash other than the last prior hash that was received.

13. The method of claim 9 further comprising resending messages sent to the instance after the prior hash was received.

14. One or more computing systems with a trusted execution environment (TEE) for providing to a client of an instance of an application of a secure enclave executing within a TEE evidence of current application state of that instance, the one or more computing systems comprising:
one or more computer-readable storage mediums storing computer-executable instructions for controlling the one or more computing systems to during execution of the instance:
generate a first hash of first application state of the instance;
send the first hash to the client;
direct a computing system to store the first application state persistently; and
upon restart of execution of the instance,
receive second application state from a computing system; and
send a second hash of the second application state to the client so that the client can compare the first hash and the second hash to determine whether second application state is the same as the first application state; and
one or more processors for executing the computer-executable instructions stored in the one or more computer-readable storage mediums.

15. The one or more computing systems of claim 14 wherein the computer-executable instructions include instructions to:
receive a message from the client that includes a hash of application state; and
determine whether received hash is the same as the second hash to ensure that the message is consistent with the second application state.

16. The one or more computing systems of claim 14 wherein the application maintains client-specific application state for each of plurality of clients and wherein the first hash sent to the client is a hash of the client-specific application state for that client.

17. The one or more computing systems of claim 14 wherein the computer-executable instructions include instructions to, during the restarted execution of the instance of the application, generate a third hash of third application state that is different from the second application state and send the third hash to the client.

18. The one or more computing systems of claim 17 wherein the third hash is sent to the client via a reply message to a message received from the client.

19. The one or more computing systems of claim 17 wherein a new current hash is periodically generated based on the then-current application state and sent to the client.

20. The one or more computing systems of claim 14 wherein the computer-executable instructions include instructions to, upon restarting execution of the instance of the application, generate the second hash of the second application state.

21. The one or more computing systems of claim 14 wherein the computer-executable instructions include instructions to, upon restarting execution of the instance of the application, receive from one of the computing systems the second hash.

22. A method performed by one or more computing systems for verifying state information of a secure enclave, the method comprising:
upon restart of an instance of the secure enclave,
receiving a restart hash of state information loaded by that restarted instance;
receiving a persisted signed hash loaded by that restarted instance; and
validating the state information based on the restart hash matching a previous hash received from a prior start of that instance or based on the restart hash matching the persisted signed hash and verification that the persisted signed hash was signed using a private key corresponding a public key received from a prior restart of that instance.

23. The method of claim 22 wherein a prior start is an initial start of the instance.

24. The method of claim 22 wherein a prior start is a prior restart of the instance.

25. The method of claim 22 further comprising receiving and storing a public key of a public/private keypair of the restarted instance, the public key being unique to that restarted instance.

26. The method of claim 22 further comprising receiving a current hash of current state information of the instance and storing the current hash as a previous hash.

27. One or more computing systems for providing evidence of state information of an instance of an application of a secure enclave, the one or more computing systems comprising:
one or more computer-readable storage mediums for storing computer-executable instructions for controlling the one or more computing systems to:
upon a start of the instance of the application,
send to a client a public key of the public/private keypair of the start of the instance;
generate a hash of state information of the instance;
sign the hash with the private key of the public/private keypair; and
store the state information and the signed hash; and
upon restart of the instance of the application,
receive current state information and the signed hash;
generate a current hash of the current state information; and
send to the client the current hash and the signed hash so that the client can verify that the current hash matches the signed hash and verify using the public key that the signed hash was signed using the private key; and
one or more processors for executing the computer-executable instructions stored in the one or more computer-readable storage mediums.

28. The one or more computing systems of claim 27 wherein the instructions further include instructions to generate a public/private keypair for the start of the instance.

29. The one or more computing system of claim 27 wherein the instructions that store request a host computing system to persistently store the state information and the signed hash.

30. The one or more computing system of claim 29 wherein the current state information is received from a host computing system.
